(19) United States
(12) Patent Application Publication
(10) Pub. No.: US 2013/0330695 A1
(43) Pub. Date: Dec. 12, 2013

(54) SYSTEM FOR MEDICALLY TREATING A CHILD

(71) Applicant: Pediatric Emergency Standards, Inc., Weston, FL (US)

(72) Inventor: Peter Antevy, Weston, FL (US)

(21) Appl. No.: 13/911,924

(22) Filed: Jun. 6, 2013

Related U.S. Application Data
(60) Provisional application No. 61/657,430, filed on Jun. 8, 2012.

(51) Int. Cl. G09B 23/28

(52) U.S. Cl. CPC G09B 23/28
USPC 434/262

(57) ABSTRACT

A system for medically treating a child comprising a flexible membrane, with indicia thereon, and a plurality of portions, extending distally along the membrane from the start portion. Each portion has at least a second indicia thereon. The second indicia has a characteristic indicative of the developmental age of a child disposed along the membrane. At least one book has pages, each page of the book having the one of the respective at least second indicia thereon. Each page having at least a third indicia corresponding to at least one of a medicine and dosage and the item of medical equipment and size for use with a child of the developmental age indicated by the at least second indicia.

### CROSS REFERENCE TO RELATED APPLICATION

This application claims priority to Provisional Patent Application No. 61/657,430, filed Jun. 8, 2012, the contents of which are incorporated by reference.

### BACKGROUND OF THE INVENTION

This application is directed to a system for resuscitating a child, and more particularly, to a system which utilizes coding to link the developmental age of a child to the appropriate equipment and/or drug dosages in a way that alerts all in the treatment area of these appropriate dosages and equipment sizes.

The dose of medication and the size of medical equipment must be appropriate if the patient is to receive the best treatment. In an emergency situation, selections must be made quickly and under pressure; with life and death consequences.

The selection of the appropriate dosage of medication or the appropriate sized instrument becomes more acute when dealing with pediatric patients. By way of example, endotracheal tubes have as many as ten different diameters which may be used to secure the airway of a patient. The time required to identify the appropriate endotracheal tube and then select the appropriate tube from a collection of endotracheal tubes would be costly to the treatment process, putting the patient at critical risk. Picking too big a tube could damage the airways, permanently hurting or even killing the patient.

A similar scenario is involved with creating the appropriate volume dosage of a medication.

In an attempt to streamline the process, it is known in the art to use the Broselow Measuring Tape which has indicia thereon for measuring a patient. The indicia represents increments in body weight of the patient. Indicia for drug dosages, tube sizes and other medical equipment sizes are disposed on the tape near the corresponding indication for that child's estimated weight.

The prior art has been satisfactory, however during emergency treatment, because the dosages and equipment indication are printed on the measuring tape, it makes use of the tape difficult. The tape requires constant adjustment and movement of the tape relative to the body of the person being measured in order to measure the length of the child, determine the recommended dosages and equipment, all at the same time confirming that the initial reading was correct. The system is limited to the drugs and dosages printed on the tape making changes to the system difficult, and ignoring some necessary treatments. Lastly, the tape lists milligram dosages of drugs requiring health care providers to perform a mathematical calculation for the use of each drug. These shortcomings often result in prescribing the wrong medication dosage or selecting the wrong sized equipment.

One attempt to overcome the shortcoming is to measure a specific anatomical dimension correlated to a code. The code may be a color or a pattern which is used to identify and select medication dosage, medical equipment and/or medical supplies. The equipment and medication supplies are grouped by this code and contained in packages bearing the code.

Although this overcomes some of the shortcomings of the prior art; in a situation where a team is involved with treating a pediatric patient, they must all rely on the initial read and the conveyance of that information to the group by the person who determines the code in order for them to select equipment. This lends itself to miscommunication and makes true team care difficult and prone to error. Again, this may result in mistreatment which may result in death. Furthermore, Broselow provides no mechanism for double checking medicine calculations.

Accordingly, a system which overcomes the shortcomings of the prior art is desired.

### BRIEF SUMMARY OF THE INVENTION

A system for medically treating a child includes a flexible membrane with indicia thereon. At least a first indicia indicates a start point for measuring the child, and at least a second indicia has a characteristic indicative of the developmental age of the child disposed along the membrane. At least one book has a page corresponding to at least one of the at least second indicia. In one embodiment of the invention, the at least one page within the book has the at least second indicia thereon, and a third indicia identifying equipment size corresponding to the proper equipment for a child having the developmental age indicated by the at least second indicia. A page within the book having the at least second indicia thereon and a fourth indicia indicating a volume dosage of medicine to be administered to a child of the developmental age indicated by the at least second indicia.

In another embodiment of the invention, a second book has a page therein having the at least the second indicia thereon for placing in plain view.

### BRIEF DESCRIPTION OF THE DRAWINGS

The present disclosure is better understood by reading the written description with reference to the accompanying drawing figures, in which the reference numerals denote the similar structure and refer to the element throughout in which:

FIG. 1 is a schematic representation of one embodiment of a linear strip incremented with indicia in accordance with the invention;

FIG. 2 is a cover of a book indicative of age, color and weight in accordance with the invention;

FIG. 3 is a page from the age, color, weight guide constructed in accordance with the invention;

FIG. 4 is a book for use in an emergency room in accordance with the invention;

FIGS. 5a and 5b are a page of the book shown in FIG. 4 listing drug information for administering drugs corresponding to the developmental age of a patient as indicated in accordance with the invention;

FIG. 6 is a second page of the book indicating equipment to be utilized for a child of the developmental age indicated in accordance with the invention;

FIGS. 7a and 7b are a poster for use in a hospital or other treating facility in accordance with the invention;

FIG. 8 is a perspective view of a kit constructed in accordance with the invention; and

FIG. 9 is a badge constructed in accordance with the invention having indicia thereon for the administration of medication as a function of the developmental age of the patient in accordance with the invention.

### DETAILED DESCRIPTION OF THE PREFERRED EMBODIMENT

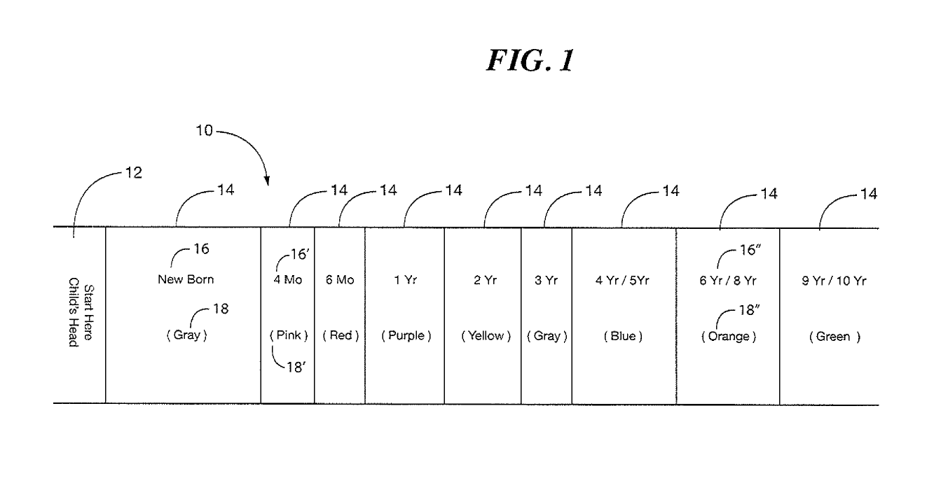

Reference is first made to FIG. 1 which is a strip, generally indicated as 10, preferably formed from a flexible material for use in determining an indicia 16, 18 corresponding to the developmental age of a child. The strip 10 includes a first region 12 which is indicia for the start of the measurement to properly orient the patient quickly and clearly. Region 12 is preferably formed of a clear bright color to make the start point easily recognizable. In a preferred embodiment, text, such as START HERE may be placed within region 12.

A plurality of regions 14 extend from start region 12 along the entire length of strip 10. The relative distance of a distal portion relative to proximal region 12 is indicative of the developmental age of the child, so that the foot of the child laid along strip 10 if landing within a region 14 will correspond to a developmental age indicated by either indicia 16 or 18, or both. Indicia 16 is a word text indicating a developmental age corresponding to the developmental age represented by a respective region 14. Furthermore, a portion of the region may have a non-text indicia 18 such as a background color in a non-limiting exemplary embodiment.

In this way, a first region 14 corresponding to newborns, will have the word newborn text indicia 16 spelling out NEWBORN and a background color indicia of gray, whereas a second region 14 having text indicia 16′ corresponding to a four month old and a differentiating background color indicia 18′ of pink. This differentiation indicia occurs along strip 10 such as text indicia 16″ indicating a six year old through an eight year old with a single non-text background color indicia 18″ of orange.

No two regions 14 will have the same non-text (color) indicia or text indicia. In other words, a respective non-text indicia 18 and/or text indicia 16 corresponds to its own region 14 which is a function of developmental age. The indicias 16, 18 are selected to be clearly distinguishable from each other and readily recognizable.

It should be understood that strip 10 described above may be of any length to accommodate additional age groups or more bifurcated age groups than those shown in FIG. 1. Additionally, the key is the use of different colors and indicia in strip 10 as well as in other corresponding members of the system, not the specific colors themselves.

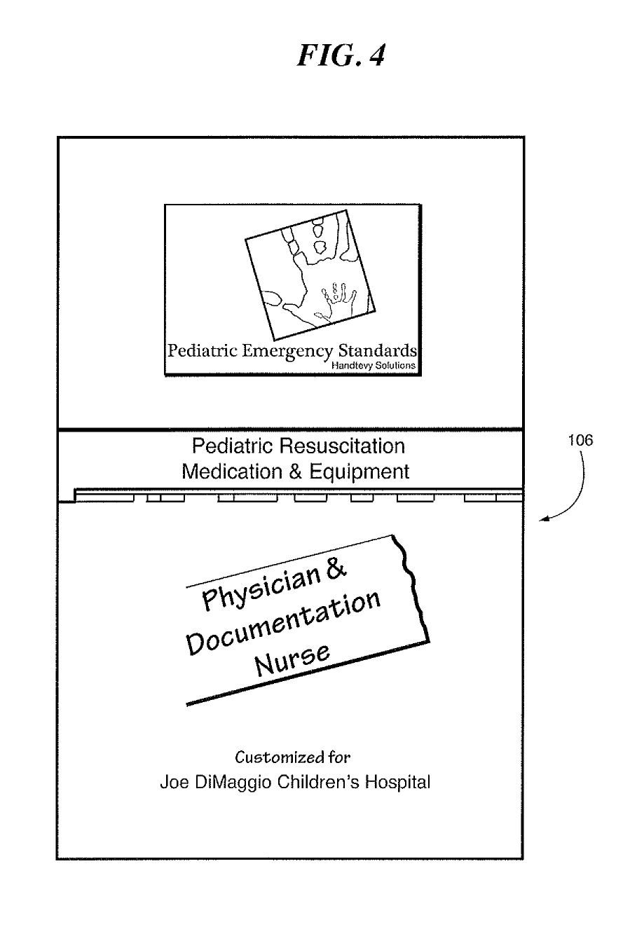

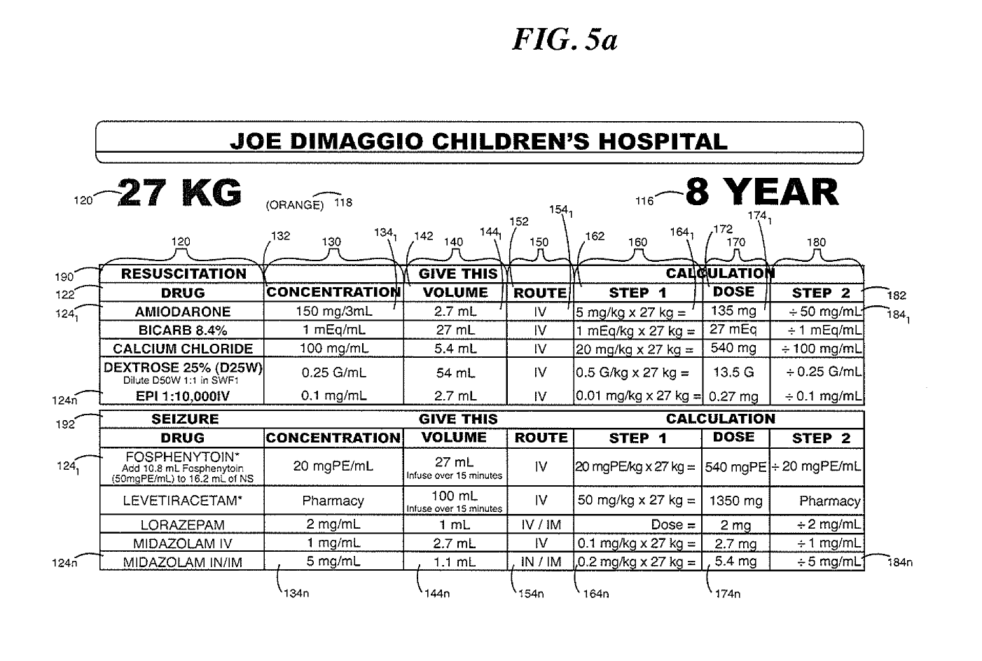

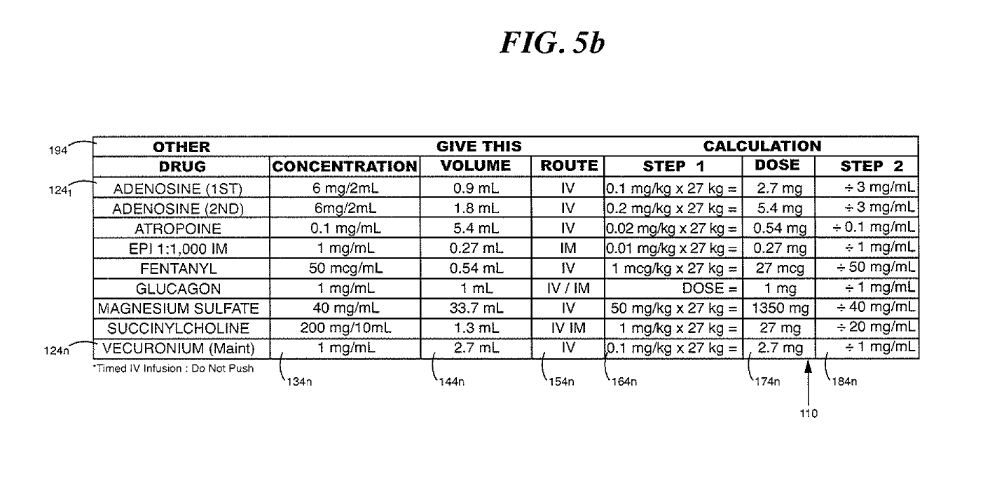

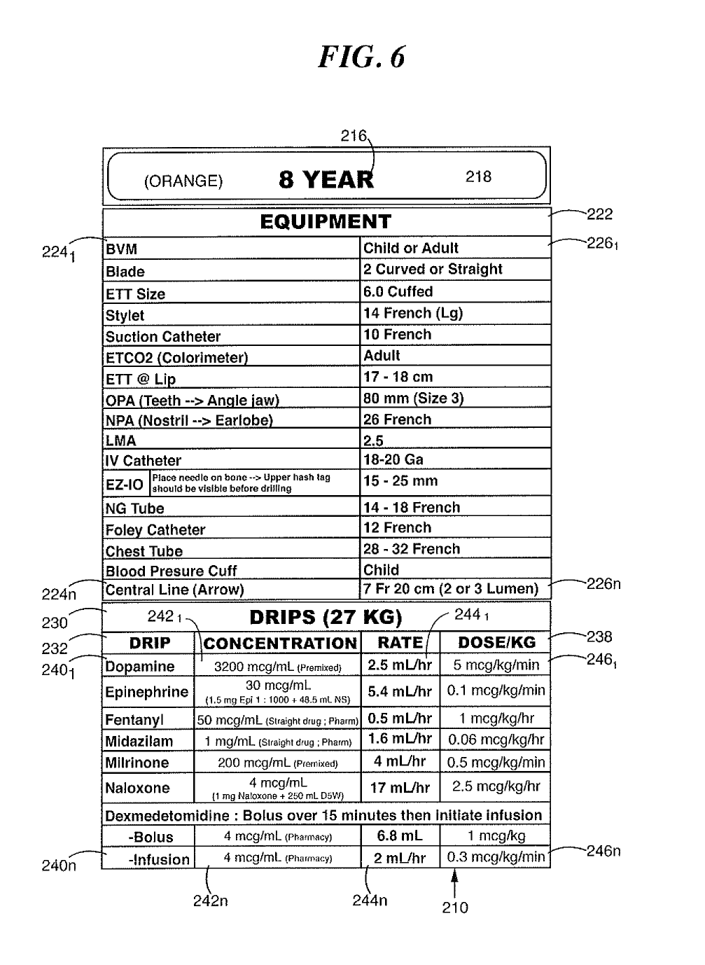

This system includes a series of books, at least one of which includes information about equipment and medication to be used in resuscitation of a child. Reference is now made to FIG. 4 in which a book 100 for use by the treating physician and/or documentation nurse in resuscitating a child is provided. Pediatric Resuscitation Medication and Equipment Book (PRME) 100 includes pages such as pages 110 and 210 (see FIGS. 5-6).

In general, each page corresponds to information related to treating a child of a developmental age as indicated utilizing strip 10. Indicia corresponding to at least one of indicia 16 and 18 is prominently displayed on each of pages 110 and 210.

Turning specifically, to page 110 by way of example, page 110 includes indicia 116, 118 which corresponds to indicia 16, 18 of strip 10 for easy and consistent reference. Therefore, by way of example, page 110 includes information for the administration of drugs to treat an eight year old child. The non-text indicia 118 may be presented in one of two ways as a background to text indicia 116 or as the actual color of text indicia 116.

Often the administration of drugs is not only a function of developmental size, but of weight. Therefore, in a preferred, non-limiting embodiment, indicia 120 indicating an average weight of an eight year old child is provided. Again, this indicia may be expressed in the color corresponding to the developmental age of an eight year old as found in indicia 16 of a region 14 of strip 10.

The table at page 110 includes columns corresponding to information required for the proper administration of a drug. Column 120 includes indicia for the drug to be administered. Column 130 is the concentration of the drug. Column 40 corresponds to the volume of the drug to be administered. Column 150 indicates the method of administration, intravenous (IV), intranasal (IN), or intramuscular (IM). Column 160 corresponds to the first calculation for determining the amount of the drug to be administered as a function of the weight of the child. Column 170 indicates the milligram dosage to be administered and column 180 corresponds to a step two; the mathematical equation required to convert from mg to ml. Each of the columns is indicated by “drug” indicia 122, “concentration” indicia 132, “volume” indicia 142, “route” indicia 152, “step one” indicia 162, “dose” indicia 172, and “step two” indicia 182, so that the attendant making use of this information readily knows what the information within each column means.

Page 110 includes drug dosage indicia set up as a chart to easily and readily provide information for the proper dosage and administration of the drugs to be used. Although the system may be used for the treatment of a child in any medical situation, it is particularly designed to facilitate the rapid treatment of a child in an emergency situation, such as those found by in an emergency room treating physician or an emergency responder.

As a result, in a first organization methodology, the drugs are grouped by the activity for which they are most likely to be administered. Accordingly, a first category 190 is resuscitation while a second group 192 is seizure and a third group 194 is all other foreseeable emergency response drugs. Within each category, drug indicia 124 are listed as indicia for drugs 124₁-124ₙ in alphabetical order within each category 190, 192, 194. By way of example, the first drug indicia 124₁ of group 190 for resuscitation is AMIODARONE. Similarly, the first drug indicia in group 192 for administration for seizure has indicia 124₁ to indicate FOSPHENYTOIN, and lastly the first drug indicia listed in group 194 is indicated as indicia 124₁ to indicate ADENOSINE.

The proper dosage and administration of drugs are often prepared on the fly in situ. Accordingly, the next category within each group is the concentration 132, the desired volume of the drug, the route 150, as indicated by indicia 152 and the method of calculation to prepare the correct administration including the calculations needed to be done in a step one column 160 to determine the dose as indicated by indicia 174₁-174ₙ in column 170 and in the second step column 180.

It should be noted, that while medicine is a science, there are many ways to treat the same condition. Each hospital, each emergency response vehicle, may have its own protocol for treating the same condition. Therefore, each book may be customized with respect to medication and treatment procedures chosen by each group.

In one embodiment, the drugs required for treating a particular condition may be listed in the order needed for treatment prior to intubation of a child. Although three groups of procedures have been shown above, listings may be broken out by other specific procedures for conditions such as cardiac arrest, seizures, rapid sequence induction (RSI), and overdose reversal. By way of non-limiting example three different regimens of RSI: General RSI (patients who do not fall into the following two categories), Increased Intracranial Pressure (ICP RSI), and SEPSIS RSI may be broken out into their own groups.

Reference is now made to FIG. 6 in which a second page 210 of PRME 100 having equipment indicia thereon is shown. A page 210 includes indicia 216, 218 corresponding to a child having a developmental age of eight years, which is substantially identical to the indicia 16, 18 in portion 14 of strip 10 corresponding to a child of eight years old. Namely, text indicia 216 indicates eight years on a non-text background indicia 218, which in this non-limiting example, is the same color as the eight year developmental age portion 14 (orange).

Page 210 includes an equipment section indicated by equipment heading 222 and an application section indicated by application heading 230. There is a single equipment indicia column identifying equipment by name in each row 224₁-224ₙ, and a second column with rows 226₁-226ₙ indicating the size but only for the size of equipment appropriate for the child of a developmental age indicated by either one of indicia 216, 218.

Additionally, a drug application indicia 230 such as drip rates may be provided on the same page. Continuous Infusion section 230 includes a column 232 having drug indicia 240₁-240ₙ indicating the drug to be continuously infused. A concentration column headed by indicia concentration 234 includes concentration values 242₁-242ₙ for the drugs indicated in the adjacent column. A next column 236 indicating the rate of continuous infusion includes specific rates as shown by indicia 241₁-244ₙ for the drugs indicated under the continuous infusion indicia 232. Lastly, dose indicia 238 heads a column of indicia for actual dosages for each drug, dose indicia 246₁-246ₙ corresponds to a child having eight year developmental age for the drugs indicated. Accordingly, a treating physician or attendant, by reading across the row, would know for a desired drug (listed in substantially alphabetical order) the concentration, the rate and the dosage.

The above system is a new and improved system for insuring that the proper medicine dosage and size of equipment is utilized on a child. However, in an emergency situation, where multiple attendees are administering to a child, all of the responders may not literally be on the same page. It should be noted, that several books 100 may be in use within the same treating area at a single time, or a single book may be shared between several attendants. By way of example, in an emergency room setting, where there will be the attending physician and at least one attending nurse, if not more, each of which must put down the book in order to perform their tasks, there is a probability that at least one of the attendants will end up on the wrong page. Therefore, to even better aid the entire treating team, a portion of the system provides an aid for keeping track of the page within book 100 to be referenced.

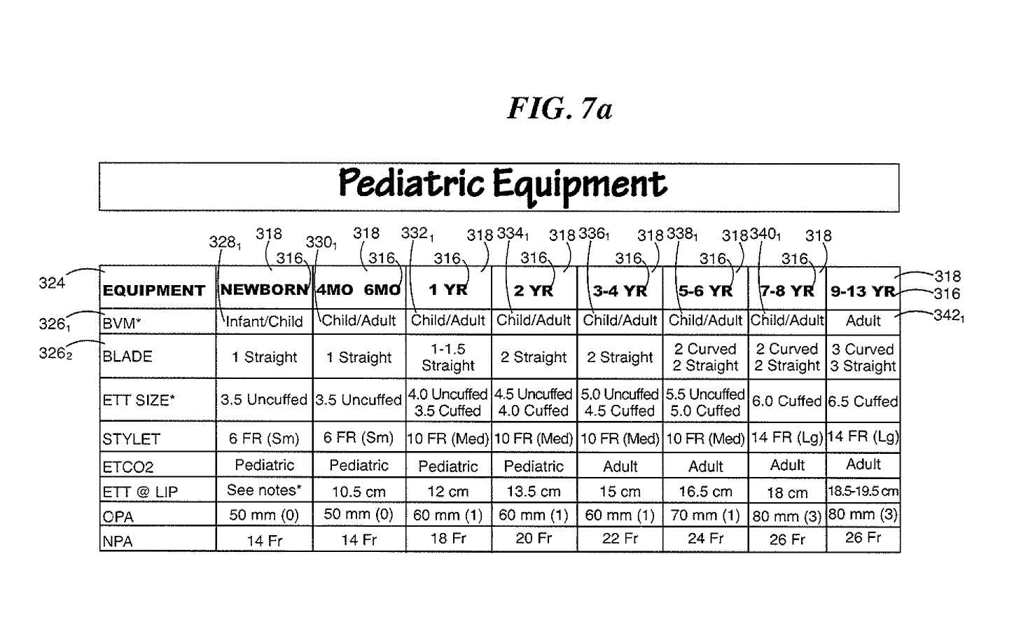

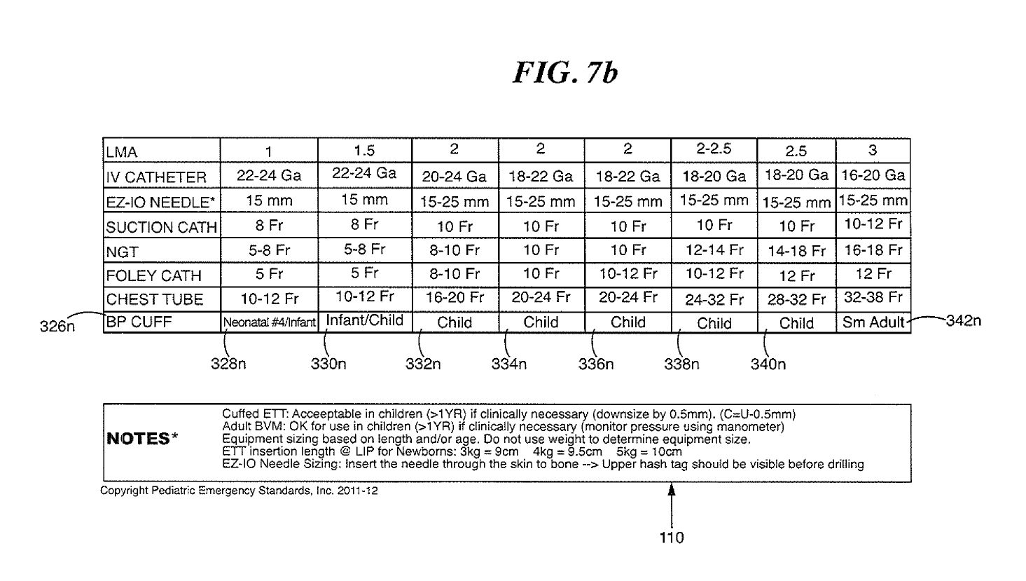

Reference is now made to FIGS. 7a-7b in which a poster 310 corresponding to the medical equipment to be utilized in treating a child is provided. Poster 310 contains much of the information on pages 110 and 210 and is placed in a conspicuous place so as to viewed by all attendants. Poster 310 is also arranged in the form of a table. The first column has equipment indicia 324, and lists equipment to be used in any procedure. Because this is a poster, it is to be used in situ; it preferably contains information for all anticipated procedures in one place, rather than having multiple posters for each procedure. Therefore, each of the remaining columns includes indicia corresponding to each respective portion 14 of strip 10. Each column head has a text indicia 316 and a non-text indicia 318, such as color, which corresponds to the text indicia 16 and non-text indicia 18 of a respective one of each portion of strip 10 in a one to one match.

Accordingly, row 324 has indicia of equipment 326₁-326ₙ corresponding to pediatric equipment to be used in anticipated emergency procedures. The subsequent rows of each of the columns include indicia for the size of the equipment indicated in indicia 326 for the developmental age indicated by the indicia heading of each column.

By way of example, a blade as indicated from 326₂ is a size one straight, as indicated in indicia 328₂ and 330₁ for a newborn through six month old. However, reading across the row, the blade to be used if the column head indicates a five to six year old is a 2 curved or 2 straight as indicated by indicia 334₂. Similarly, a blood pressure cuff as indicated by indicia 326ₙ in the equipment column (reading across the row) is an infant/child sized blood pressure cuff as indicated by indicia 330ₙ for a four month old or six month old, and a small adult size as indicated by indicia 342ₙ for a nine to thirteen year old. In this way, a quick reference guide is provided to select the right size equipment as a function of determining the developmental size utilizing strip 10.

It should be noted that one important aspect of the invention is to provide information linked to indicia determinative of developmental age as determined from strip 10. The information within book 100 is presented in a way that makes selecting the correct page or instrument simple; facilitating the reading of the desired information from the page. Therefore, there are many alternative ways for those skilled in the art to present the information. Also, it should be noted that a poster 310 may just as easily include medical dosage indicia.

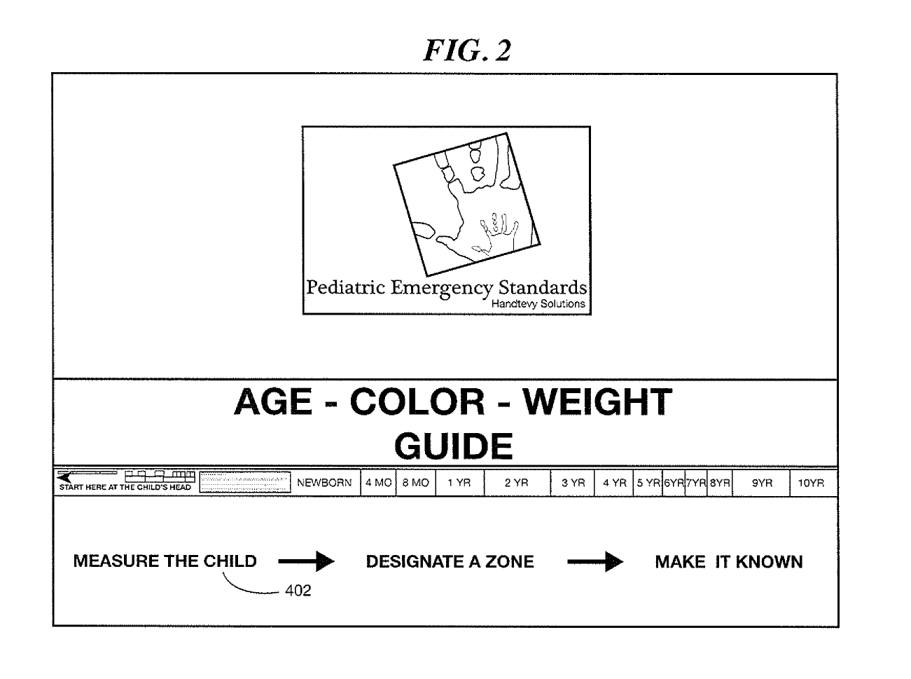

Reference is now made to FIG. 2 in which book 400 which is an age color weight guide constructed in accordance with the invention is provided. Book 400 includes on its cover indicia 402 with operating instructions for use of the book. The indicia indicates that first a child is measured with strip 10, the zone is determined by the head-to-heel length of the child as compared to strip 10, and then the indicia 16,18 in this non-limiting example, color, or actual developmental age number is to be made known to all of the attendants.

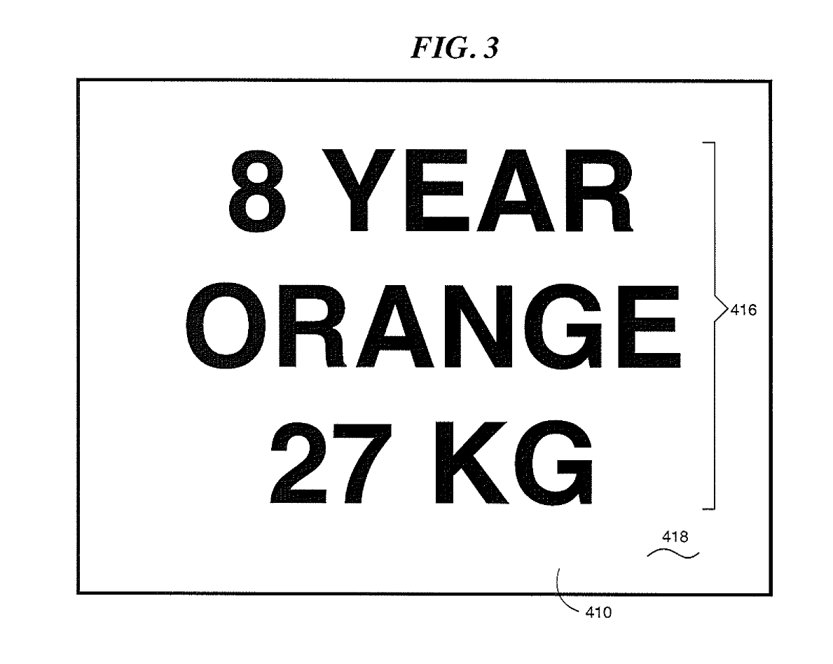

Reference is now made to FIG. 3 which is a page 410 within age, color, weight guide book 400 which is used to make the region 14 (zone) known to all attendants. Page 410 includes a non-text indicia 418 which is a background color corresponding to the non-text indicia of a region 14 on strip 10. It also includes text indicia 416 which includes at least the development text of the developmental age of the child as determined utilizing strip 10, indicates the color of the background for anyone who may be color blind or for easy reference for those who read more quickly than the recognized color, and optionally the ideal body weight of a child of that developmental age.

In this non-limiting example, the background non-text indicia 416 of page 410 would be a color such as orange, corresponding to a color of a non-text indicia 18 of strip 10, and also corresponds to the non-text indicia of the page corresponding to the indicated developmental age within PRME 100 of the appropriate developmental age child.

During use, a child suffering a critical condition needing resuscitation, or some other acute care is identified. The child is laid head-to-heel along strip 10, with the head at indicator 12. The strip is laid along the child to determine within which portion 14 the heel resides. The indicator 16, 18 is determined.

Book 400 is opened to the page having indicia 416, 418 corresponding to the indicia of 16, 18 of the determined portion 14. The page is then placed in a prominent position within the room for all attendants to see. Then, each of second books 200 is opened to the page having indicia 116, 118, by way of example, corresponding to a displayed page of book 400, which also corresponds to the determined portion 14 of strip 10. Then, treatment begins utilizing the medicine and equipment as determined from the tables on the respective pages of the PRME book 100. In this way, the attendants do not have to remeasure the child to continuously confirm the developmental age; facilitating movement of the child during any procedure.

It should be readily understood, that if in the field, one would skip the step of utilizing age, color, weight, guide book 400. In a non-preferred embodiment, age, weight guide book 400 may also be skipped even in the hospital emergency room situation. However, this may increase the likelihood of human error.

Although the system, as described above, provides the system and methodology for recognizing the appropriate medicine and equipment, it does not guarantee that the appropriate medicine and equipment is utilized. Therefore, as a further component to facilitate the correct equipment and medication, it is also part of the system to arrange the equipment within discrete packages in which all of the equipment or all of the medicine to be administered corresponds to the medicine and equipment indicated to belong to a child of that developmental age.

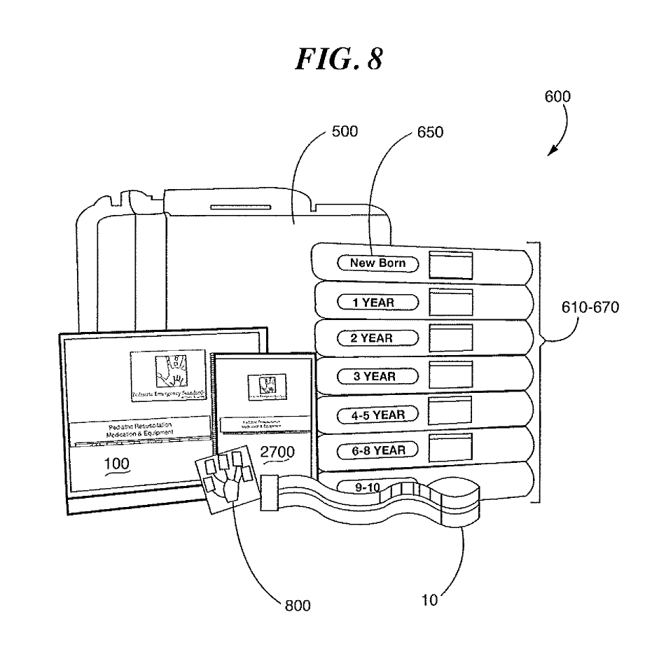

Reference is now made to FIG. 8 in which a system 600 for use in the field is provided. Like numbers are utilized to indicate like structure for ease of discussion. System 600, which is adapted for use in the field includes strip 10, and PMRE 100. Because system 600 is for the field, system 600 includes a carrying case 500 for storage of medical equipment and books 100 and/or 700. Book 700 is identical in functionality to book 100. It is well within the scope of the invention that in the field, only one book need be used at the discretion of the emergency response team operator.

System 600 includes a plurality of packages 610-670, each having indicia 650 thereon for indicating a developmental age of a child corresponding to a portion 14 of strip 10. Within each package may be stored equipment corresponding to that developmental age and/or proposed medication corresponding to the developmental age of the child indicated by indicia 650. In this way, it may be possible, at least as to equipment, to skip the use of PMRE 100. In another embodiment, preferred embodiment PMRE 100 lists only medications.

In a preferred embodiment, packages 600 are lightweight pliable pouches having interior compartments designed to receive the equipment identified within PMRE 100. It should be understood, that in a hospital situation, packages 610-670 may be replaced by a cabinet with packages formed as drawers 610-670 with indicia 650 on the outer door of each drawer.

In emergency situations, the ability to make determinations quickly and easily while maintaining accuracy is important. Therefore, any component of the system must have indicia which is easily determined to correspond to the identified portion of strip 10.

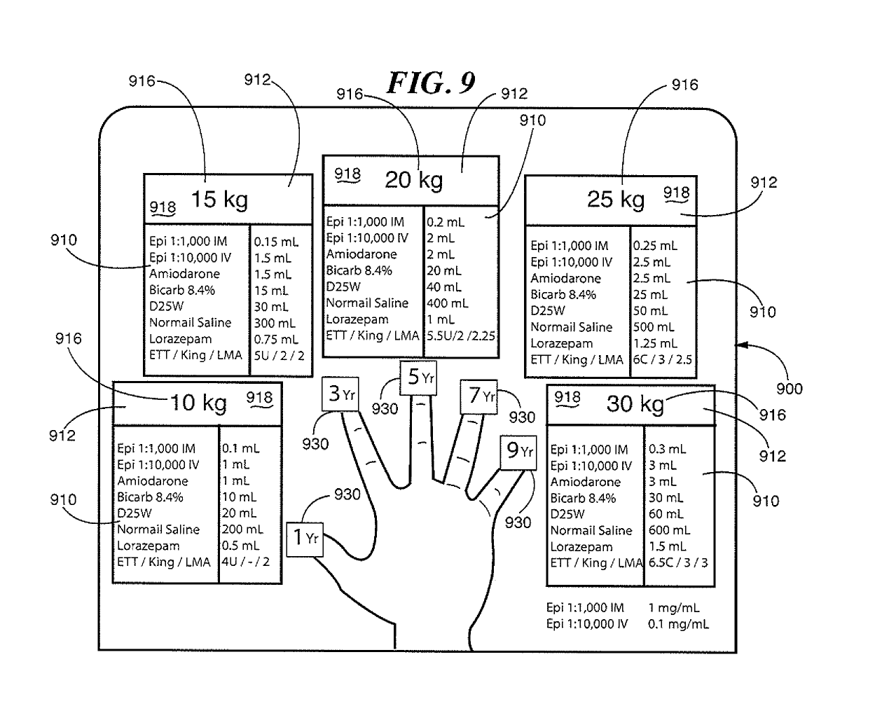

To facilitate the determination of drug dosages in the field, a responder may use a badge 900 as shown in FIG. 9. Badge 900 includes tables 910, each including indicia 912 include a non-text indicia component 918, which may be a background color by way of example corresponding to non-text indicia 18 of strip 10, and text indicia 916 corresponding to the developmental age indicated by indicia 918 and 18. Each table 910 includes a list of the drugs and equipment needed for the anticipated emergency, in this case, resuscitation, so that in a first column drugs and equipment are indicated and in an adjacent column dosage and size of equipment are provided for a quick reference. Furthermore additional indicia 930 corresponding to the text indicia 18 and non-text indicia 16 of each portion 14, may also be provided adjacent the corresponding table 910 for additional quick reference.

While this invention has been particularly shown and described to reference the preferred embodiments thereof, it would be understood by those skilled in the art that various changes in form and detail may be made therein without departing from the scope of the invention encompassed by the appended claims.

What is claimed as new and desired to be protected by Letters Patent of the United States is:

1. A system for medically treating a child comprising:
a flexible membrane, with a first indicia thereon, and a plurality of portions, extending distally along the membrane from the first indicia, each portion having at least a second indicia thereon, the second indicia having a characteristic indicative of the developmental age of a child disposed along the membrane; and
at least one book, each page of the book having a respective one of the at least second indicia corresponding to a respective portion of the membrane, each page having at least a third indicia corresponding to at least one of a medicine and dosage and an item of medical equipment and size for use with a child of the developmental age indicated by the at least second indicia.

2. The system of claim 1, further comprising a second book, each page of the second book having a respective second indicia thereon.

3. The system of claim 1, wherein the second indicia includes at least one of a non-text indicia and a text indicia.

4. The system of claim 3, wherein the text indicia is the developmental age of the child.

5. The system of claim 1, further comprising a badge, the badge having a plurality of tables thereon, each table including a respective one of the at least a second indicia, and a third indicia indicating at least one of a medicine and dosage and equipment and size to be used with a child having a developmental age indicated by the at least second indicia.

6. The system of claim 3, wherein the non-text indicia is a color

7. The system of claim 1, wherein a position of a second indicia on the flexible memory relative to another second indicia on the flexible membrane is a function of a length from the first indicia, corresponding to the developmental age of the child.

8. The system of claim 1, wherein the third indicia indicative of a medicine is grouped on a page of the at least one book as a function of the activity for which the medicine is to be administered.

9. The system of claim 1, wherein the third indicia includes a medicine administration route.

10. The system of claim 1, wherein the third indicia includes a concentration of the medicine, a volume of the medicine, and a calculation for calculating dosage of the medicine as a function of average weight for the developmental age indicated by the second indicia.

11. The system of claim 1, wherein the second indicia at each page of the book indicating the developmental age of a child and the average weight of a child of that developmental age.

12. The system of claim 1, further comprising a poster having a respective one of the at least second indicia corresponding to a respective portion of the membrane, and having at least a third indicia corresponding to at least one of a medicine and dosage and an item of medical equipment and size for use with a child of a developmental age indicated by the at least second indicia.

13. The system of claim 1, further comprising a plurality of packages, each package having indicia having a respective second indicia thereon.

14. The system of claim 13, wherein each page of the plurality of packages is a lightweight pliable pouch having interior compartments to receive the equipment identified in the at least one book corresponding to the respective second indicia on the package.

15. The system of claim 13, wherein each of the plurality of packages is a drawer within a cabinet, the second indicia being on the drawer.

16. A method for treating a child providing the steps of:
measuring a child with a flexible membrane by placing a first indicia of the membrane at one end of a child to be treated and extending the membrane along the length of the child;
the membrane including a plurality of portions extending distally along the membrane from the first indicia, each portion having at least a second indicia thereon, the second indicia having a characteristic indicative of the developmental age of a child disposed along the membrane;
determining which second indicia corresponds to the other end of the child being measured;
providing at least one book, each page of the book having a respective one of the at least second indicia corresponding to a respective portion of the membrane, each page having at least a third indicia corresponding to at least one of a medicine and dosage and an item of medical equipment size for use with a child of the developmental age indicated by the at least second indicia;
referencing the at least one book to determine which medicine and medical equipment to be used to treat the child.

17. The method of claim 16, further comprising the step of providing a poster, the poster having the second indicia and third indicia corresponding to the developmental age of the child as determined from the measurement.

18. The method of claim 16, wherein the second indicia includes at least one of a non-text indicia and a text indicia.

19. The method of claim 16, further comprising the step of providing a container for storing medical equipment corresponding to a determined developmental age of a child, the container having the second indicia thereon corresponding to the determined developmental age.
